(19) United States
(12) Patent Application Publication
(10) Pub. No.: US 2005/0013212 A1
(43) Pub. Date: Jan. 20, 2005

(54) Optical pickup apparatus

(75) Inventor: Tsutomu Matsui, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD

(21) Appl. No.: 10/860,274

(22) Filed: Jun. 4, 2004

(30) Foreign Application Priority Data
Jun. 6, 2003 (JP) P. 2003-161525

(51) Int. Cl. G11B 7/00

(52) U.S. Cl. 369/44.15; 369/44.22

(57) ABSTRACT

In an optical pickup apparatus which includes an objective lens which condenses laser light on a recording surface of an optical disk, and a lens holder which holds the objective lens and whose location can be changed, a detection coil for a proximity sensor is disposed on a top surface of the lens holder. The detection coil detects a distance to the recording surface of the optical disk which is made of a metallic material, and control is provided so that the objective lens will not contact the optical disk.

### BACKGROUND OF THE INVENTION

1. Field of the Invention

The present invention relates to an optical pickup apparatus which records information on an optical disk and replays information from the optical disk while utilizing laser light, and more particularly, to an effective technique which is applicable to an optical pickup apparatus which is compatible with an optical disk for a blue-violet laser which demands an objective lens whose working distance is short.

2. Description of the Related Art

A plurality of types of optical disks such as an optical disk which permits large-capacity recording and replaying using a blue-violet laser are in practical use, in addition to CDs (compact disk) and DVDs (digital versatile disk).

It is necessary to use short-wavelength laser light to record on and replay from a large-capacity optical disk, and additionally, condensation of the laser light on a recording surface of the optical disk requires an objective lens whose numerical aperture is as large as “NA=0.85” for instance. Further, an objective lens whose numerical aperture is large has a working distance from the end of the lens to the focal point of as short as 0.1 mm through 0.3 mm for example.

In a conventional optical pickup apparatus, with an objective lens held by a lens holder which is supported so that the location of the lens holder can be changed, information is recorded and replayed while the lens holder is driven under servo control in a focus direction of laser light and a tracking direction which corresponds to the radius direction of an optical disk. Such servo control is performed by means of feedback of reflected light from the optical disk. Hence, during an ordinary operation, the optical disk and the objective lens are maintained apart from each other by a certain distance which corresponds to a working distance.

However, in the event that relatively large amount of dust, fingerprints or scratches, etc., are attached to the optical disk, for instance, their influence over the reflected light could deviate a feedback signal for servo control, thereby making it temporarily impossible to provide servo control in the focus direction. Upon occurrence of such an error, although retracting operation is carried out to return to a normal state so as to refocus after information record/replay processing has been stopped, there is a risk that owing to servo control based on wrong reflected light existing at the time of the error occurrence or immediately before recognition of the error, the lens holder could move close to the optical disk and the objective lens could touch the optical disk.

This problem is more significant as the working distance of the objective lens is shorter.

### SUMMARY OF THE INVENTION

The object of the present invention is to provide an optical pickup apparatus which securely guarantees no contacting of an objective lens and an optical disk even upon occurrence of an error during focus servo control for instance.

To achieve the object above, in an optical pickup apparatus according to a first aspect of the present invention which includes an objective lens, which focuses laser light on a recording surface of an optical disk, and a lens holder which holds the objective lens and whose location can be changed, a detection coil for a proximity sensor is disposed on the lens holder. The detection coil detects a distance to the recording surface of the optical disk which is made of a metallic material, thereby guaranteeing that the objective lens will not contact the optical disk.

According to the first aspect of the invention, even upon occurrence of an error during servo control in a focus direction because of dust and the like on the optical disk, the distance to the optical disk is detected independently of this, and therefore, it is possible to securely prevent contacting of the objective lens and the optical disk.

To be specific, the detection coil above is attached to the surface of the lens holder which faces the objective lens. This attains favorable detection sensitivity.

Further, according to a second aspect of the present invention, at least two such detection coils are arranged side by side in a radial direction which intersects the direction of rotation of the optical disk so that the objective lens is located between the detection coils.

According to the second aspect of the present invention, the two detection coils above detect the inclination of the optical disk along the radius direction, in addition to the distance to the optical disk. Further, based on the detection, it is possible to provide servo control for the tilt angle of the lens holder which corresponds to the inclination of the optical disk described above.

It is desirable to dispose a detection circuit which outputs a signal of 100 kHz or more to the detection coil and detects the distance between the detection coil and the optical disk.

In general, in the case of a lens holder, since servo control in the focus direction, the tracking direction and the direction of the tilt angle (Control of the tilt angle is not executed in some cases.) is realized often utilizing electromagnetic force, magnetism used for such servo control also affects the detection coil. Noting this, detection processing is performed using a high-frequency signal as described above and the influence of signals having lower frequencies is eliminated, whereby accurate detection is realized while removing the influence of magnetism exerted by other control such as servo control. Further, since the band of a signal used for servo control has an upper limit of about 2 kHz, during processing of distance detection, use of a signal of 100 kHz or more reduces crosstalk between the two to a degree. In addition, crosstalk between the two can be eliminated without fail at about 1 MHz±10%.

### BRIEF DESCRIPTION OF THE DRAWINGS

These and other objects and advantages of this invention will become more fully apparent from the following detailed description taken with the accompanying drawings in which:

FIG. 1 is a perspective view which partially shows the lens holder in the optical pickup apparatus according to the first embodiment of the present invention;

FIG. 2 is a drawing of the proximity detection circuit which uses the detection coil shown in FIG. 1;

FIG. 3 is a characteristic graph which shows a relationship between the output from the proximity detection circuit and the distance between the detection coil and the recording surface;

FIG. 4 is a perspective view which partially shows the lens holder in the optical pickup apparatus according to the second embodiment of the present invention; and

FIG. 5 is a drawing of the proximity detection circuit which uses the detection coil shown in FIG. 4.

### DETAILED DESCRIPTION OF THE PREFERRED EMBODIMENTS

Embodiments of the present invention will now be described with reference to the associated drawings.

### First Embodiment

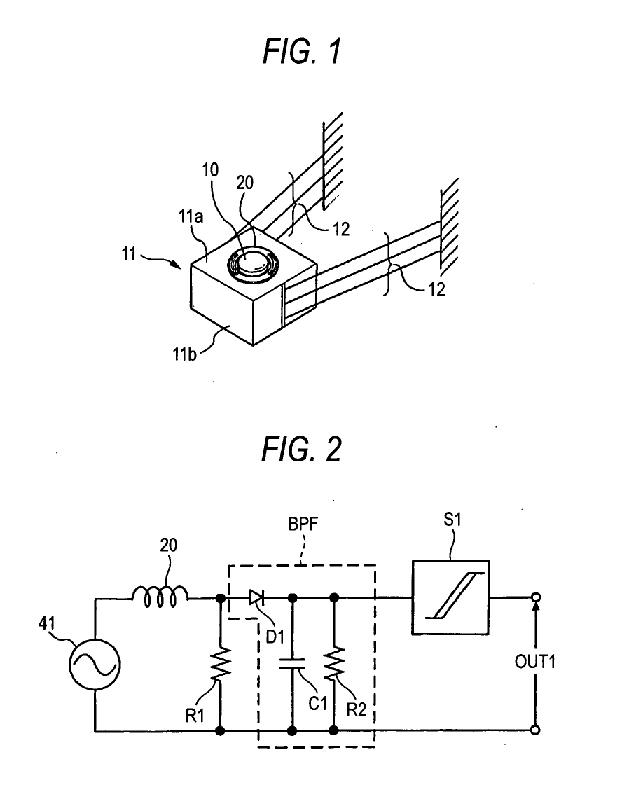

FIG. 1 is a perspective view which partially shows a lens holder in an optical pickup apparatus according to a first embodiment of the present invention.

The optical pickup apparatus according to this embodiment irradiates laser light upon a recordable DVD or a blue-violet laser optical disk for instance, and records and replays information.

This optical pickup apparatus includes, as shown in FIG. 1, an objective lens 10 which condenses laser light on a recording surface of an optical disk, a lens holder 11 which holds the objective lens 10 and which is supported so that the location of the lens holder can be changed, and although not shown, a drive device which drives the lens holder 11 in a focus direction and a tracking direction, a light emitting element such as a semiconductor laser, a light receiving element such as a laser diode, and an optical system which guides laser light to the objective lens and guides reflected light to the light receiving element is provided. The optical system, the light receiving element and the like above include those which detect a feedback signal used for servo control in the focus direction and the tracking direction, in addition to those which detect replay information.

A support structure for the lens holder 11 is such a structure which supports by means of wires 12 whose one ends are fixed. A drive device for the lens holder 11 exerts drive force over the lens holder 11 owing to electromagnetic force, and provides drive independently in the focus direction and the tracking direction. Hence, although not shown, a magnet is disposed at a location facing a sidewall 11b while a plurality of coils are disposed on the side wall 11b of the lens holder, whereby these coils carry current via any four of the wires 12.

Further, in the optical pickup apparatus according to this embodiment, a detection coil 20 for a proximity sensor is attached to a top surface 11a of the lens holder 11 so that the objective lens 10 is surrounded by the detection coil 20. The detection coil 20 is a circular coil which is an extremely thin wound wire, and the top end of the detection coil 20 is fixed at a lower position than the top end of the objective lens 10. This detection coil is connected between the remaining two wires among the wires 12 which are not used for servo control.

FIG. 2 is a structure drawing of a proximity detection circuit which is connected with the detection coil 20.

As shown in FIG. 2, connected with one end of the detection coil 20 via the wires 12 and 12 are an oscillator 41 which outputs a pulse signal whose frequency is 1 MHz±10%, a resistor R1 which converts the current carried by the detection coil 20 into voltage, a band pass filter BPF formed by a diode D1 which is connected in series to one terminal of a resistor R1 and a capacitor C1 and a resistor R2 which are connected in parallel between both terminals of the resistor R1, and a Schmidt circuit S1 which shapes the waveform of a signal passing through the band pass filter BPF.

The band pass filter BPF above passes a signal which is within a frequency range including 1 MHz determined by the frequency characteristics of a low pass filter, which is formed by a resistance component of the diode D1 and the capacitor C1, and a high pass filter which is formed by a capacitance component of the diode D1 and the resistor R2.

A distance between the detection coil 20 and a metal plate which is in the proximity of the same is detected from a value which is obtained by integrating an output voltage OUT 1 of this circuit. In other words, the recording surface of the optical disk is made of a metallic material as understood from fact that the recording surface has a metallic luster, and since mutual inductance between the detection coil 20 and the recording surface changes as the distance between these two changes, the current carried by the detection coil 20 changes in accordance with the pulse signal from the oscillator 41, and as the band pass filter BPF, the Schmidt circuit S1 and the like extract and measure the amount of change, the distance between the detection coil 20 and the recording surface of the optical disk is detected.

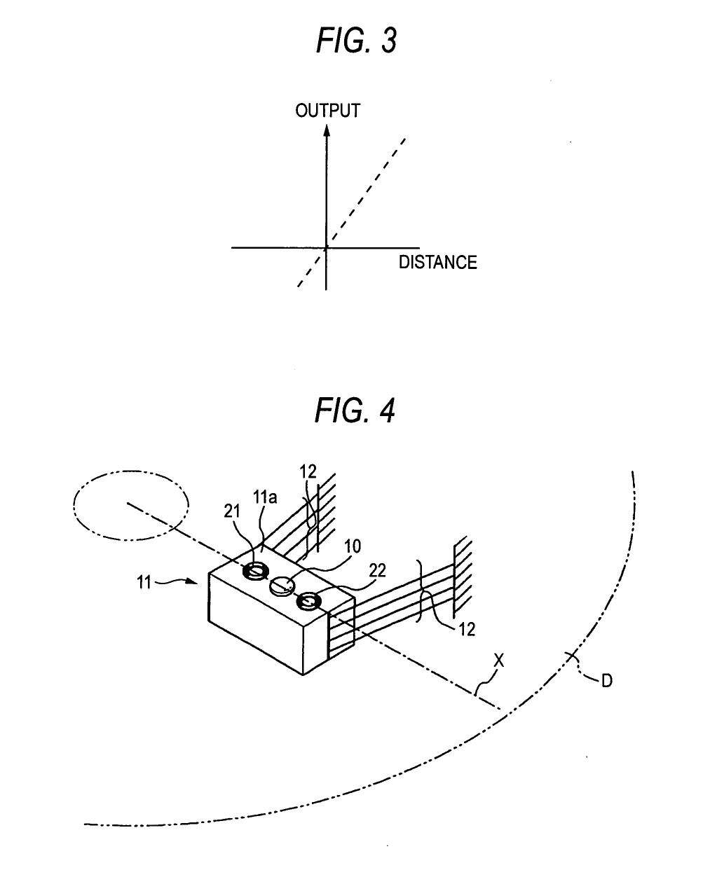

FIG. 3 is a characteristic graph which shows a relationship between the integrated output from the circuit of FIG. 2 and the distance between the detection coil and the recording surface.

As shown in FIG. 3, the relationship between the output from the circuit of FIG. 2 and the distance is approximately linear, which realizes detection of the distance at an extremely high accuracy and a high resolution.

In the optical pickup apparatus according to this embodiment, the detection coil 20 and the detection circuit detect the distance between the objective lens 10 and an optical disk independently of servo control even upon occurrence of an error during servo control in the focus direction because of dust and the like on the optical disk, and hence, it is possible to securely prevent the objective lens 10 from contacting the optical disk. Such control is easily realized, as the drive device for the lens holder 11 outputs a signal which makes the lens holder 11 descend when the output from the proximity detection circuit reaches or exceeds a certain level for instance.

Further, although the lens holder 11 is subjected to other magnetism which is used for driving of servo control, since a signal of 1 MHz is outputted to the detection coil 20 and the band pass filter BPF removes signals of 2 kHz or less which are used for servo control, it is possible to detect a precise distance without any crosstalk with another control signal. While the Schmidt circuit S1 is disposed within the detection circuit in this embodiment above for the purpose of removal of the influence of a very small noise, the Schmidt circuit S1 may be omitted if there is no particular problem.

### Second Embodiment

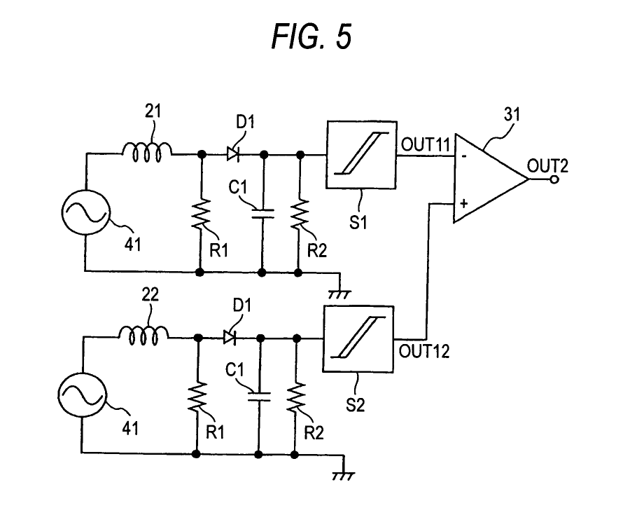

FIG. 4 is a perspective view which partially shows a lens holder in an optical pickup apparatus according to a second embodiment of the present invention, and FIG. 5 is a drawing of a proximity detection circuit.

In the optical pickup apparatus according to the second embodiment, detection coils 21 and 22 for magnetic proximity sensors are attached to a top surface 11a of a lens holder 11, the inclination of an optical disk D along the radius direction is detected in accordance with outputs from these magnetic proximity sensors and servo control in the direction of the tilt angle of the lens holder 11 is performed based on the detection.

Hence, in this embodiment, the two detection coils 21 and 22 are fixed to the lens holder 11 in such a manner that the detection coils are arranged side by side in the radius direction of the optical disk (i.e., the X-axis direction in FIG. 4) on the both sides of the objective lens 10. Further, there are two more wires 12, so as to apply voltages independently upon the two detection coils 21 and 22.

In addition, as shown in FIG. 5, the same detection circuit as that shown in FIG. 2 is connected with each one of the detection coils 21 and 22, and an operation amplifier 31 compares outputs OUT11 and OUT12 from these, thereby obtaining an output OUT2 which is indicative of a difference between a distance from a disk surface to one detection coil 21 and a distance from the disk surface to the other detection coil 22, namely, the inclination of the optical disk along the radius direction.

The output OUT2 is fed back to a servo control circuit responsible for the tilt angle, and the direction of the tilt angle is controlled so that the inclination will be “0”.

Although only the inclination of the optical disk is detected using the detection coils 21 and 22 and the distance between the objective lens 10 and the optical disk is not detected in this embodiment, it is possible to detect the distances between the optical disk and the respective detection coils 21 and 22 by means of separate inputting of the outputs OUT11 and OUT12, control to avoid contacting of the objective lens 10 and the optical disk may be executed in line with servo control for the tilt angle described above.

The present invention is not limited to the preferred embodiments above but may be modified in various manners. For instance, although the embodiments described above are directed to an example where the detection coils are attached to the top surface 11a of the lens holder 11, the detection coils may be attached at locations which are slightly inward of the lens holder 11.

Further, while the second embodiment is directed to an example that the two detection coils 21 and 22 are arranged, along the radius direction of the optical disk D, the direction in which the two detection coils 21 and 22 are arranged may be somewhat angled (at 30 degrees for instance) with respect to the radius direction of the optical disk as long as this direction is not at 90 degrees with respect to the radius direction of the optical disk.

In addition, although the foregoing has described that the lens holder and the drive device for the same are of the wire-supported type and the coil drive method, this is not limited. The lens holder and the drive device for the same may be of a support structure of the axial slide type and the moving magnet drive method can be adopted.

As described above, the present invention offers an effect that even upon occurrence of an error during servo control in the focus direction because of dust and the like on an optical disk, it is possible to detect a distance to the optical disk independently of this and securely prevent the objective lens from contacting the optical disk.

Further, there is another effect that it is possible to detect the inclination of the optical disk without relying upon an optical signal and control the drive of the tilt angle of the objective lens.

1. An optical pickup apparatus comprising:
an objective lens which condenses laser light on a recording surface of an optical disk;
a lens holder which holds the objective lens and whose location can be changed;
a detection coil for a proximity sensor which is disposed on the surface of the lens holder which faces the objective lens; and
a detection circuit which outputs a signal of 100 kHz or more to the detection coil and detects a distance between the detection coil and an optical disk.

2. An optical pickup apparatus comprising:
an objective lens which condenses laser light on a recording surface of an optical disk;
a lens holder which holds the objective lens and whose location can be changed; and
a detection coil for a proximity sensor which is disposed on the lens holder.

3. The optical pickup apparatus according to claim 2, wherein
the detection coil is attached to the surface of the lens holder which faces the objective lens.

4. The optical pickup apparatus according to claim 3, wherein
there are two such detection coils which are arranged side by side in a direction which intersects the direction of rotation of an optical disk so that the objective lens is located between the detection coils.

5. The optical pickup apparatus according to claim 2, comprising:
a detection circuit which outputs a signal of 1 MHz±10% to the detection coil and detects a distance between the detection coil and an optical disk.
